(19) United States
(12) Patent Application Publication
(10) Pub. No.: US 2026/0170038 A1
(43) Pub. Date: Jun. 18, 2026

(54) SYSTEMS AND METHODS FOR PERSONA-BASED DATA RETRIEVAL

(71) Applicant: JPMORGAN CHASE BANK, N.A., New York, NY (US)

(72) Inventors: Nivas SHANKAR, Randolph, NJ (US); Karthick Praveen Kumar APPADURAI BASKARAN, Montville, NJ (US); Hemathri BALAKRISHNAN, Frisco, TX (US); Sudhakar NAGARAJAN, Frisco, TX (US); Naveen JD, North Brunswick, NJ (US); Nirmala SISTLA, Sammamish, WA (US); Santosh BARDWAJ, Lincolnshire, IL (US); Hari Krishna KC, Sanford, FL (US); Bhartendu AKHILESH, Coppell, TX (US); Sekhar ACHANTA, Houston, TX (US); John PAULSON, McKinney, TX (US)

(21) Appl. No.: 18/978,699

(22) Filed: Dec. 12, 2024

(51) Int. Cl. G06F 16/335; G06F 16/3329; G06F 16/3332; G06F 16/34; G06F 16/383

(52) U.S. Cl. CPC G06F 16/337; G06F 16/33295; G06F 16/3332; G06F 16/345; G06F 16/383

(57) ABSTRACT

A method may include: (1) receiving, by a computer program executed by an electronic device and from a user electronic device for user, a question in natural language regarding metadata in a data lake; (2) converting, by the computer program and using a large language model, the question into a graph query; (3) presenting, by the computer program, the graph query to a graph database, wherein the graph database is pre-populated with the metadata in the data lake; (4) receiving, by the computer program, a response from the graph database; (5) summarizing, by the computer program and using the large language model, the response from the graph database in natural language; and (6) returning, by the computer program, the summary to the user electronic device.

### BACKGROUND OF THE INVENTION

### 1. Field of the Invention

Embodiments relate to systems and methods for persona-based data retrieval.

### 2. Description of the Related Art

Large organizations often store their information in a data lake, which is a centralized repository that ingests and stores large volumes of data in its original form. When data lakes are extremely large, their metadata will also be large. This metadata may include DB, table, columns, data type, user details, documentation, operational logs, storage and cost metrics. Since the metadata is also large and scattered in different tools and environments, it is very difficult to access them and get the required information (from the metadata).

### SUMMARY OF THE INVENTION

Systems and methods for persona-based data retrieval are disclosed. In one embodiment, a method may include: (1) receiving, by a computer program executed by an electronic device and from a user electronic device for user, a question in natural language regarding metadata in a data lake; (2) converting, by the computer program and using a large language model, the question into a graph query; (3) presenting, by the computer program, the graph query to a graph database, wherein the graph database is pre-populated with the metadata in the data lake; (4) receiving, by the computer program, a response from the graph database; (5) summarizing, by the computer program and using the large language model, the response from the graph database in natural language; and (6) returning, by the computer program, the summary to the user electronic device.

In one embodiment, the metadata comprises catalogs, logs, documentation, and metrics from the data lake.

In one embodiment, the response from the graph database comprises a database element.

In one embodiment, the method may also include: reviewing, by the computer program, the question for unacceptable content and for relevance.

In one embodiment, the method may also include: rewriting, by the computer program, the question by replacing words in the question with synonyms.

In one embodiment, the synonyms comprise metadata in the graph database.

In one embodiment, the large language model uses retrieval augmented generation to convert the question into the graph query.

According to another embodiment, a method may include: (1) receiving, by a computer program executed by an electronic device and from a user electronic device for user, the user associated with a persona, a question in natural language regarding metadata in a data lake; (2) converting, by the computer program and using a large language model, the question into a graph query; (3) retrieving, by the computer program, past questions from the user; (4) creating, by the computer program, a personalized frequently asked question list comprising the question and the past questions, wherein the frequently asked question list is ranked based on a frequency; (5) presenting, by the computer program, the personalized frequently asked question list to the user; (6) receiving, by the computer program, a selection of one of the questions in the personalized frequently asked question; (7) converting, by the computer program and using a large language model, the question into a graph query; (8) presenting, by the computer program, the graph query to a graph database, wherein the graph database is pre-populated with the metadata in the data lake; (9) receiving, by the computer program a response from the graph database; (10) summarizing, by the computer program and using the large language model, the response from the graph database in natural language; and (11) returning, by the computer program, the summary to the user electronic device.

In one embodiment, the persona is based on a role of the user within an organization.

In one embodiment, the method may also include: reviewing, by the computer program, the question for unacceptable content and for relevance.

In one embodiment, the method may also include: rewriting, by the computer program, the question by replacing words in the question with synonyms.

In one embodiment, the synonyms comprise metadata in the graph database.

In one embodiment, the large language model uses retrieval augmented generation to convert the question into the graph query.

According to another embodiment, a non-transitory computer readable storage medium may include instructions stored thereon, which when read and executed by one or more computer processors, cause the one or more computer processors to perform steps comprising: receiving, from a user electronic device for user, a question in natural language regarding metadata in a data lake; converting, using a large language model, the question into a graph query; presenting the graph query to a graph database, wherein the graph database is pre-populated with the metadata in the data lake; receiving a response from the graph database; summarizing, using the large language model, the response from the graph database in natural language; and returning the summary to the user electronic device.

In one embodiment, the metadata comprises catalogs, logs, documentation, and metrics from the data lake.

In one embodiment, the response from the graph database comprises a database element.

In one embodiment, the non-transitory computer readable storage medium may also include instructions stored thereon, which when read and executed by the one or more computer processors, cause the one or more computer processors to perform steps comprising: reviewing the question for unacceptable content and for relevance.

In one embodiment, the non-transitory computer readable storage medium may also include instructions stored thereon, which when read and executed by the one or more computer processors, cause the one or more computer processors to perform steps comprising: rewriting the question by replacing words in the question with synonyms.

In one embodiment, the synonyms comprise metadata in the graph database.

In one embodiment, the large language model uses retrieval augmented generation to convert the question into the graph query.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for persona-based data retrieval according to an embodiment;

FIG. 2 depicts a method for persona-based data retrieval according to an embodiment;

FIG. 3 depicts a method for persona-based data retrieval according to an embodiment;

FIG. 4 depicts an exemplary computing system for implementing aspects of the present disclosure.

### DETAILED DESCRIPTION OF PREFERRED EMBODIMENTS

Embodiments relate to systems and methods for persona-based data retrieval.

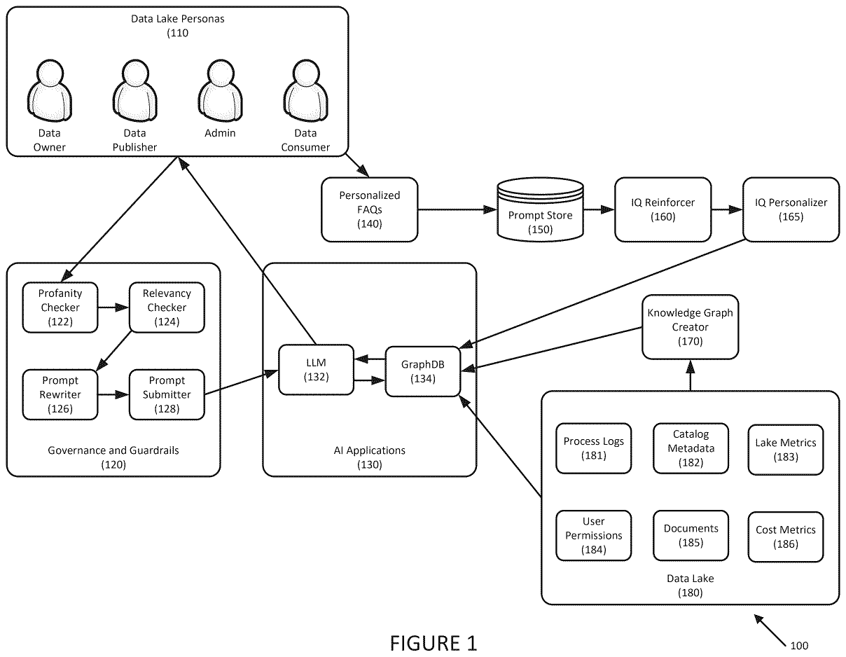

Referring to FIG. 1, a system for persona-based data retrieval is disclosed. System 100 may include data lake personas 110. Data lake personas 110 are personas of individuals that may access data in data lake 180. For example, data lake personas may include a data owner, a data publisher, a data administrator, and a data consumer.

System 100 may further include governance and guardrails modules 120, which may include checks on the query from one of the data lake personas. For example, governance and guardrails modules 120 may include profanity checker module 122 that may check the contents of the query for unacceptable content (e.g., offensive words or phrases); relevancy checker module 124 that may check the contents of the query for relevance to the persona, the organization, etc. ; prompt rewriter module 126 that may rewrite or reform the prompt using, for example, proper synonyms and prompt submitter module 128 that may submit the re-written prompt to AI applications 130.

In one embodiment, prompt rewriter module may access synonyms file, which may include a list of commonly used synonyms within an organization, and may use the synonym file to identify any replacement words. For example, the synonym file may identify synonyms for words that may be used as graph database metadata (e.g., nodes, edges, and their properties). Thus, when the LLM receives the prompt, the words in the graph database may be used to write a correct graph query.

AI applications 130 may include large language model (LLM) 132, which may receive the re-written prompt from prompt submitter module 128 and output a graph query.

Graph database 134 may receive the query from LLM 132, executes the query, and may return a graph database response to LLM 132 for summarization. For example, LLM 132 may convert the graph database response to natural language.

System 100 may include personalized frequently asked questions (FAQ) module 140 that may present FAQs to the data lake personas to execute. The FAQs may be personalized to the persona.

Prompt store 150 may receive and store user prompts from the data lake personas and may generate personalized FAQs from the prompts.

IQ reinforcer module 160 may revise prompts from prompt store 150 based on the data lake persona.

IQ personalizer module 165 may read the stored prompts and may create a personalize FAQ list per user.

Knowledge graph creator module 170 may create knowledge graphs based on the data owner's recommendation.

Data lake 180 may include process logs 181, technical catalog metadata 182, lake metrics 183, user permissions 184, documents or data 185 and cost metrics module 186.

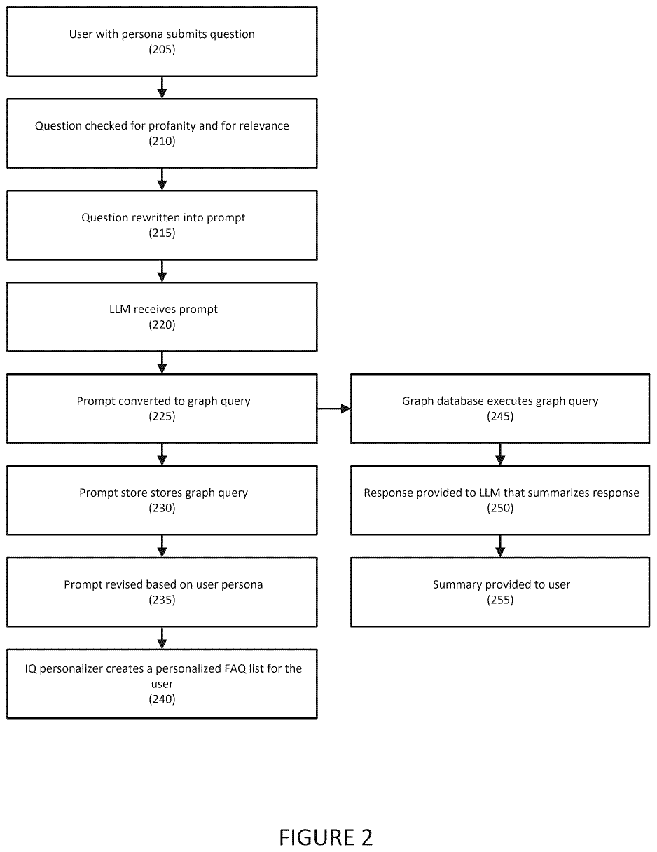

Referring to FIG. 2, a method for persona-based data retrieval according to an embodiment.

In step 205, a user that may be associated with a data lake persona (e.g., data owner, data publisher, administrator, or data consumer) may submit a question regarding metadata in a data lake. The question may be submitted using a user electronic device.

In step 210, a governance and guardrails module may review the question for profanity (e.g., any unacceptable content in the question) and for relevance (e.g., to ensure that the question is relevant to a line of business, etc.).

In step 215, the governance and guardrails module may rewrite the question into a prompt by replacing words with more appropriate synonyms. For example, the governance and guardrails module use a synonym file that includes a list of commonly used words and their corresponding synonyms, to replace certain incoming words with their synonyms in order to make the prompt more generic (e.g., replacing a specific system name with its common name). The prompt may then be submitted to an artificial intelligence module.

In step 220, a LLM in the artificial intelligence module may receive the prompt and, in step 225, may rewrite or convert the prompt (which is in natural language) to a graph query. For example, a natural language question may be “What are the databases in my application APP_ID?”. The LLM may convert this into a graph query, which may be the following:

“g.V().properties().hasValue(‘<APP_ID>’)”.

In one embodiment, the LLM may be trained with the metadata in the data lake, and may identify the schema and metadata to generate the graph query.

For example, using the metadata that may be provided in a file (e.g., a JSON file), the LLM may generate the query using Retrieval Augmented Generation (RAG). Thus, the LLM will use the data in the file as its knowledge base to generate the graph query. Because specific metadata is used to generate the graph query, the graph query will be relevant.

In one embodiment, in step 230, when the LLM converts the prompt into a graph query, the graph query may be stored. For example, the graph query may be associated with the requesting user and stored in a database, such as a prompt store. This may be used to generate the personalized FAQs for each user.

In step 235, an IQ reinforcer may receive the graph query and may revise it based on the user's persona. For example, the IQ reinforcer may review the graph query for the user question and the user submitting the question, and may internally rank the graph query against graph queries for other questions the user made in the past. Then it will find any questions which was asked repeatedly (e.g., sort the questions and assign a rank in descending order).

For example, when a user submits a question for the first time, the question may have a low ranking. As the user asks more questions, the questions may be tracked and used to generate the personalized FAQs for the user.

In step 240, an IQ personalizer may read the stored prompts from the prompt store and may create a personalized FAQ list for the user.

In step 245, which may be performed in parallel with steps 230-240, the graph query may be presented to a graph database, which may execute the graph query. For example, the graph database may be pre-populated with relevant data from the data lake, such as the metadata for the data in the data lake. Examples of metadata may include the data lake's catalog, logs, documentation, metrics, etc.

New metadata may be added to the graph database by using, for example, a knowledge graph creator.

For example, the graph database may perform a series of steps to execute the graph query in a conventional manner. This may include parsing the query (e.g., parsing the query to make sure it follows the syntax, and converting the query to its internal representations); planning the query (e.g., optimizing the query); selecting indexes based on what it identified in the query planning steps; executing the query parallelly; and consolidating and presenting the results.

The response from the graph database may be a JSON data element that is retrieved from the graph database.

In step 250, the response may be returned to the LLM, which may use the question and the response to generate a summary of the graph response. An example JSON response from the graph database to the LLM is {“db_names”: [“cust_db1”,“cards_db”]}. The LLM may take the result and convert it to natural language. Thus, an example of the natural language for the example JSON response may be “The following are the databases for your application identifier: cust_db1, cards_cb”.

In step 255, the summary of the graph response may be provided to the user.

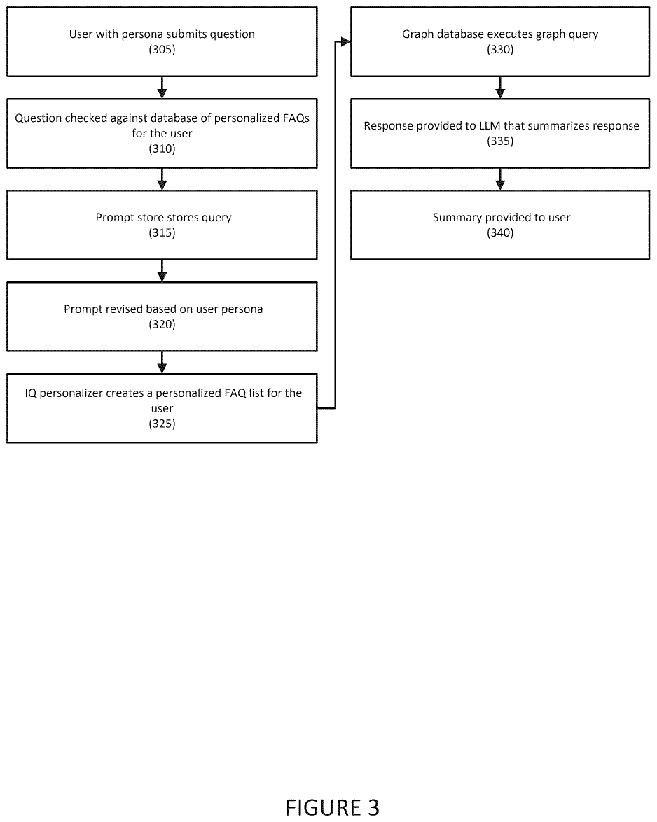

Referring to FIG. 3, a method for persona-based data retrieval according to another embodiment.

In step 305, a user that may be associated with a data lake persona (e.g., data owner, data publisher, administrator, or data consumer) may submit a question regarding data in a data lake. The question may be submitted using a user electronic device.

In step 310, the question may be checked against a database of personalize FAQs for the user. An example of such is the personalized FAQ list generated in FIG. 2.

In step 315, a prompt store may receive the prompt and may store the prompt.

In step 320, an IQ reinforcer may receive the graph query and may revise it based on the user's persona. This may be similar to step 235, above.

In step 325, an IQ personalizer may read the stored prompts from the prompt store and may create a personalized FAQ list for the user.

In step 330, the graph query may be presented to a graph database, which may execute the query. This may be similar to step 245, above.

In step 335, the response may be returned to the LLM, which may use the prompt and the response to generate a summary of the graph response.

In step 340, the summary may be provided to the user.

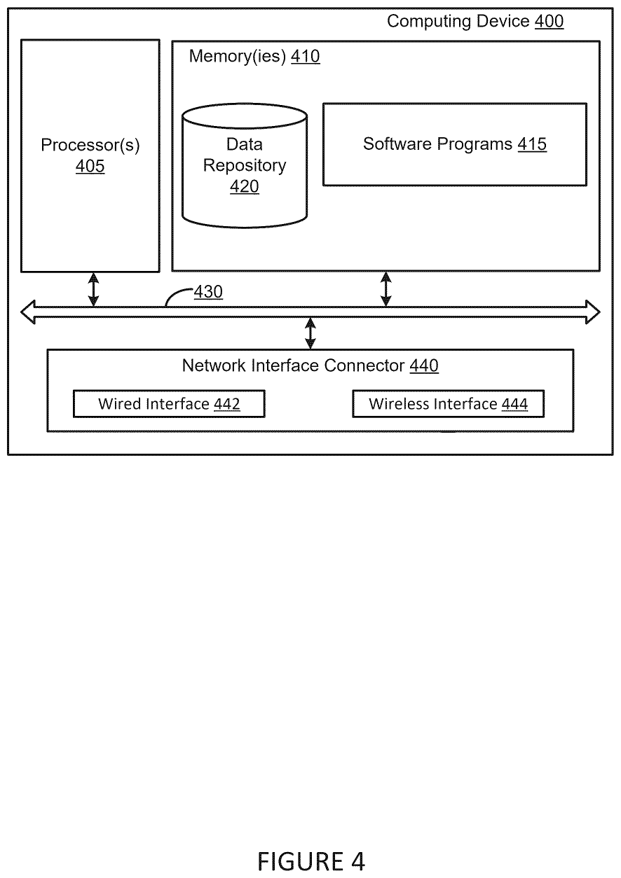

FIG. 4 depicts an exemplary computing system for implementing aspects of the present disclosure. FIG. 4 depicts exemplary computing device 400. Computing device 400 may represent the system components described herein. Computing device 400 may include processor 405 that may be coupled to memory 410. Memory 410 may include volatile memory. Processor 405 may execute computer-executable program code stored in memory 410, such as software programs 415. Software programs 415 may include one or more of the logical steps disclosed herein as a programmatic instruction, which may be executed by processor 405. Memory 410 may also include data repository 420, which may be nonvolatile memory for data persistence. Processor 405 and memory 410 may be coupled by bus 430. Bus 430 may also be coupled to one or more network interface connectors 440, such as wired network interface 442 or wireless network interface 444. Computing device 400 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

1. A method, comprising:
receiving, by a computer program executed by an electronic device and from a user electronic device for user, a question in natural language regarding metadata in a data lake, wherein the user is associated with a data lake persona, wherein the data lake persona comprises one of a data owner, data publisher, data administrator, or data consumer;
verifying, by the computer program, that the question is relevant to the data lake persona;
converting, by the computer program and using a large language model, the question into a graph query;
presenting, by the computer program, the graph query to a graph database, wherein the graph database is pre-populated with the metadata in the data lake;
receiving, by the computer program, a response from the graph database;
summarizing, by the computer program and using the large language model, the response from the graph database in natural language; and
returning, by the computer program, the summary to the user electronic device.

2. The method of claim 1, wherein the metadata comprises catalogs, logs, documentation, and metrics from the data lake.

3. The method of claim 1, wherein the response from the graph database comprises a database element.

4. The method of claim 1, further comprising:
reviewing, by the computer program, the question for unacceptable content and for relevance.

5. The method of claim 1, further comprising:
rewriting, by the computer program, the question by replacing words in the question with synonyms.

6. The method of claim 5, wherein the synonyms comprise metadata in the graph database.

7. The method of claim 1, wherein the large language model uses retrieval augmented generation to convert the question into the graph query.

8. A method, comprising:
receiving, by a computer program executed by an electronic device and from a user electronic device for user, the user associated with a persona, a question in natural language regarding metadata in a data lake, wherein the user is associated with a data lake persona, wherein the data lake persona comprises one of a data owner, data publisher, data administrator, or data consumer;
verifying, by the computer program, that the question is relevant to the data lake persona;
retrieving, by the computer program, past questions from the user;
creating, by the computer program, a personalized frequently asked question list comprising the question and the past questions, wherein the frequently asked question list is ranked based on a frequency;
presenting, by the computer program, the personalized frequently asked question list to the user;
receiving, by the computer program, a selection of one of the questions in the personalized frequently asked question;
converting, by the computer program and using a large language model, the selected question into a graph query;
presenting, by the computer program, the graph query to a graph database, wherein the graph database is pre-populated with the metadata in the data lake;
receiving, by the computer program, a response from the graph database;
summarizing, by the computer program and using the large language model, the response from the graph database in natural language; and
returning, by the computer program, the summary to the user electronic device.

9. The method of claim 8, wherein the persona is based on a role of the user within an organization.

10. The method of claim 8, further comprising:
reviewing, by the computer program, the question for unacceptable content and for relevance.

11. The method of claim 8, further comprising:
rewriting, by the computer program, the question by replacing words in the question with synonyms.

12. The method of claim 11, wherein the synonyms comprise metadata in the graph database.

13. The method of claim 8, wherein the large language model uses retrieval augmented generation to convert the question into the graph query.

14. A non-transitory computer readable storage medium, including instructions stored thereon, which when read and executed by one or more computer processors, cause the one or more computer processors to perform steps comprising:
receiving, from a user electronic device for user, a question in natural language regarding metadata in a data lake, wherein the user is associated with a data lake persona, wherein the data lake persona comprises one of a data owner, data publisher, data administrator, or data consumer;
verifying that the question is relevant to the data lake persona;
converting, using a large language model, the question into a graph query;
presenting the graph query to a graph database, wherein the graph database is pre-populated with the metadata in the data lake;
receiving a response from the graph database;
summarizing, using the large language model, the response from the graph database in natural language; and
returning the summary to the user electronic device.

15. The non-transitory computer readable storage medium of claim 14, wherein the metadata comprises catalogs, logs, documentation, and metrics from the data lake.

16. The non-transitory computer readable storage medium of claim 14, wherein the response from the graph database comprises a database element.

17. The non-transitory computer readable storage medium of claim 14, further including instructions stored thereon, which when read and executed by the one or more computer processors, cause the one or more computer processors to perform steps comprising:
reviewing the question for unacceptable content and for relevance.

18. The non-transitory computer readable storage medium of claim 14, further including instructions stored thereon, which when read and executed by the one or more computer processors, cause the one or more computer processors to perform steps comprising:
rewriting the question by replacing words in the question with synonyms.

19. The non-transitory computer readable storage medium of claim 18, wherein the synonyms comprise metadata in the graph database.

20. The non-transitory computer readable storage medium of claim 14, wherein the large language model uses retrieval augmented generation to convert the question into the graph query.
